(19) United States
(12) Patent Application Publication
(10) Pub. No.: US 2024/0145996 A1
(43) Pub. Date: May 2, 2024

(54) CONNECTOR PINS FOR REDUCING CROSSTALK

(71) Applicant: Intel Corporation, Santa Clara, CA (US)

(72) Inventors: Xiang LI, Portland, OR (US); George VERGIS, Portland, OR (US); James A. McCALL, Portland, OR (US)

(21) Appl. No.: 18/395,069

(22) Filed: Dec. 22, 2023

(51) Int. Cl. H01R 13/6471; H01R 12/73

(52) U.S. Cl. CPC H01R 13/6471; H01R 12/737

(57) ABSTRACT

A new connector implemented with connector pins to reduce crosstalk significantly improves memory channel electrical performance for next generation DDR (double data rate) technology. To reduce crosstalk the connector pins include pins with three different pin shapes, including two differently shaped signal pins and a ground pin that combines the shapes of the signal pins. The shaped pins enables them to be positioned in a connector so that each signal pin can have its own independent and separate signal return path on a single ground pin. In this manner, crosstalk can be significantly reduced.

### FIELD

This disclosure relates to connectors for coupling modules (such as memory modules) or devices with a printed circuit board such as a motherboard, and more particularly, to connectors having pins for reducing crosstalk.

### BACKGROUND

Various technologies exist for connecting devices, such as cards and modules, with a printed circuit board (PCB), such as a motherboard (MB). While it is possible to couple electronic components directly to an MB, it is common to use a connector between the MB and the card or module to enable removably coupling the card or module with the MB.

The connector includes connector pins that contact conductive leads or contacts on the card or module and on the motherboard. Crosstalk occurs when signals transmitted on one pin cause interference to signals transmitted on one or more other pins. Crosstalk can be caused by capacitive, inductive, or conductive coupling.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing at least one implementation of the invention that includes one or more particular features, structures, or characteristics. Thus, phrases such as “in one embodiment” or “in an alternate embodiment” appearing herein describe various embodiments and implementations of the invention, and do not necessarily all refer to the same embodiment. However, they are also not necessarily mutually exclusive.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is noted that the views, block diagrams and the like in the drawings are illustrative and not drawn to scale. For example, the relative dimensions and placements for some of the components in the views and block diagrams herein are exaggerated for clarity and point of illustration. For example, one having skill in the art will recognize the components in an actual implementation will generally have dimensions and thicknesses that are different than that shown in the Figures herein (e.g., substantially smaller and/or thinner), or be placed in a manner that is different from what is represented in a block diagram or other illustration.

FIG. 1 is a cross-sectional side view of an example of a device coupled with a motherboard using a connector having connector pins for reducing crosstalk in accordance with embodiments described herein;

FIGS. 2A-2D are perspective views of various connector pins for reducing crosstalk in accordance with embodiments described herein;

FIGS. 3A-3C are perspective partial views of various connector pins of a connector configured to reduce crosstalk in accordance with embodiments described herein;

FIG. 4 is a plan view of a partial reference footprint of a connector having various connector pins for reducing crosstalk in accordance with embodiments described herein;

FIG. 5 is a plan view of the partial reference footprint of FIG. 4 and a corresponding reference pinout of a connector having various connector pins for reducing crosstalk in accordance with embodiments described herein;

FIG. 6 is a graph illustrating an example comparison of prior art connector far end crosstalk and far end crosstalk for a connector having various connector pins for reducing crosstalk in accordance with embodiments described herein;

FIGS. 7A-7B are flow diagrams illustrating example processes for implementing a connector having various connector pins for reducing crosstalk in accordance with embodiments described herein; and

FIG. 8 depicts a system in which a connector having various connector pins for reducing crosstalk may be implemented in accordance with embodiments described herein.

### DETAILED DESCRIPTION

Conventional connectors, such as Double Data Rate Version 5 (DDR5) connectors formed in accordance with memory technology standard specifications originally published by JEDEC (Joint Electronic Device Engineering Council) in October 2013, or with other technologies based on derivatives or extensions of such specifications, encounter crosstalk during signal transfer. DDR5 standards define a set physical arrangement of ground pin connections, including a module pinout with certain physical distances between signal pin connections and ground pin connections to gold fingers (GF) as well as to SMT pads. DDR5 connectors can experience significant performance impacts at high data rates, especially at data rates higher than 6400 MT/S (megatransfers per second). Crosstalk limits increases in bandwidth for memory channels.

Efforts to reduce crosstalk in DDR5 connectors include using surface-mount technology (SMT) and techniques to preserve the signal-to-ground ratio of 1:1. SMT couples the connector or other component directly to the surface of the PCB. Preserving the signal-to-ground ratio to 1:1 includes techniques to close the distance between the ground pins and the signal pins to reduce crosstalk while maintaining the 1:1 ratio. However, because of DDR5 constraints, such as the limitation on reducing the DDR5 connector length, current efforts to reduce crosstalk have reached their limit.

To address this challenge, connector pins for reducing crosstalk in accordance with embodiments described herein are not constrained by certain DDR5 standards. To reduce crosstalk the connector pins include pins with three different pin shapes, including two differently shaped signal pins and a third shaped ground pin that combines the shapes of the signal pins. The shaped pins enables them to be positioned in a connector so that two signal pins can have their own independent and separate signal return paths on a single neighboring ground pin. In this manner, crosstalk can be significantly reduced. A new connector implemented with connector pins to reduce crosstalk in accordance with the described embodiments significantly improves memory channel electrical performance for next generation DDR technology.

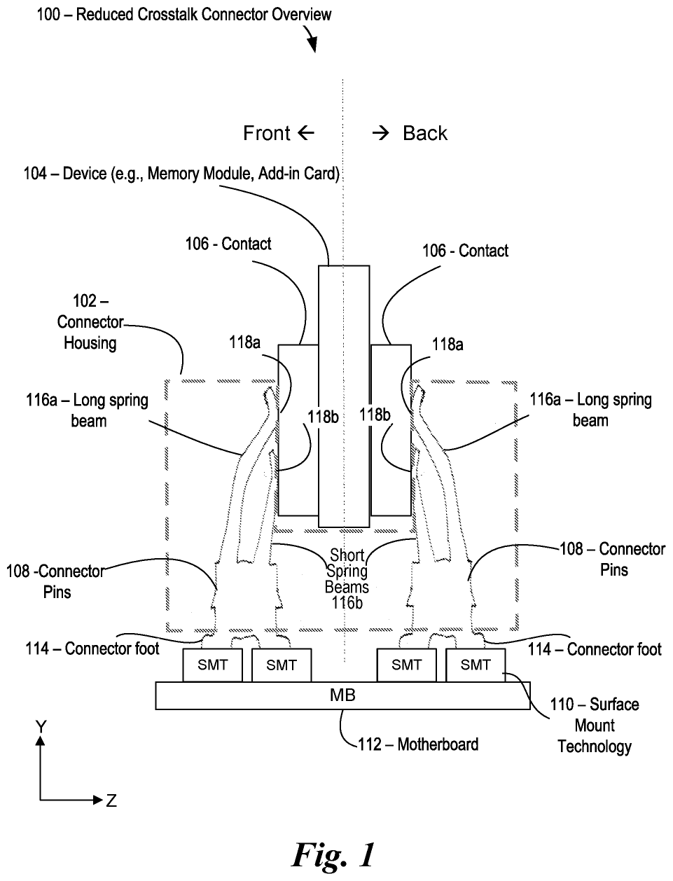

FIG. 1 is a cross-sectional side overview of an example of a device 104, such as a memory module (e.g., a dual in-line memory module (DIMM), a compression attached memory module (CAMM) or an add-in card (AIC)), coupled with a printed circuit board (PCB) such as a motherboard (MB) 112 using a reduced crosstalk connector 100. In one embodiment, connector 100 includes connector pins 108 for reducing crosstalk in accordance with embodiments described herein. The connector pins 108 pins are housed in the front and back of a connector housing 102. The connector pins 108 include a bottom portion—one or more connector feet 114 external to the housing—that is in physical and electrical contact with surface-mounted technology (SMT) 110 (e.g., a solder pad) on the surface of MB 112.

In one embodiment, the connector 100 is typically mounted to the surface of the motherboard 1 by soldering one or more connector feet 114 of the pins 108 with the SMT 110 on the surface of MB 112. The connector pins 108 also include a top portion, one or more spring beams 116, including a long spring beam 116a and a short spring beam 116b, that couple with a conductive contact 106 on or attached to the surface of the device 104. The long spring beams 116a make contact with contact 106 at an upper contact point 118a and the short spring beams 116b make contact with contact 106 at a lower contact point 118b. Conductive contacts can include pins, pads, traces, wires, terminals, leads, balls, screws, blades, or other contacts that enable formation of an electrical connection. In one embodiment, the conductive contact 106 can include a gold finger (GF) of a memory module (e.g., a DIMM).

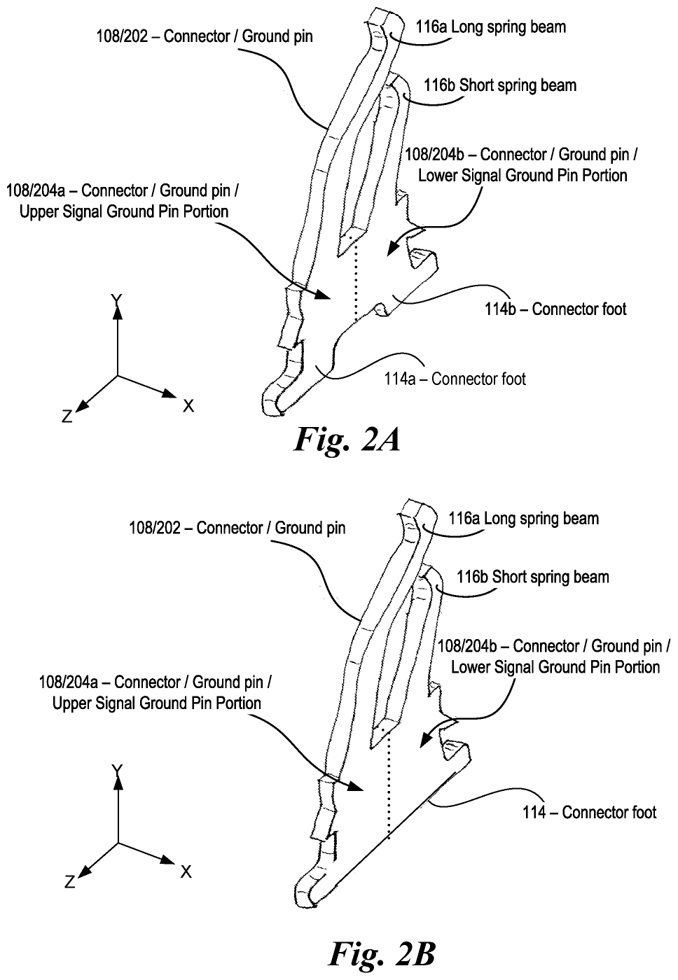

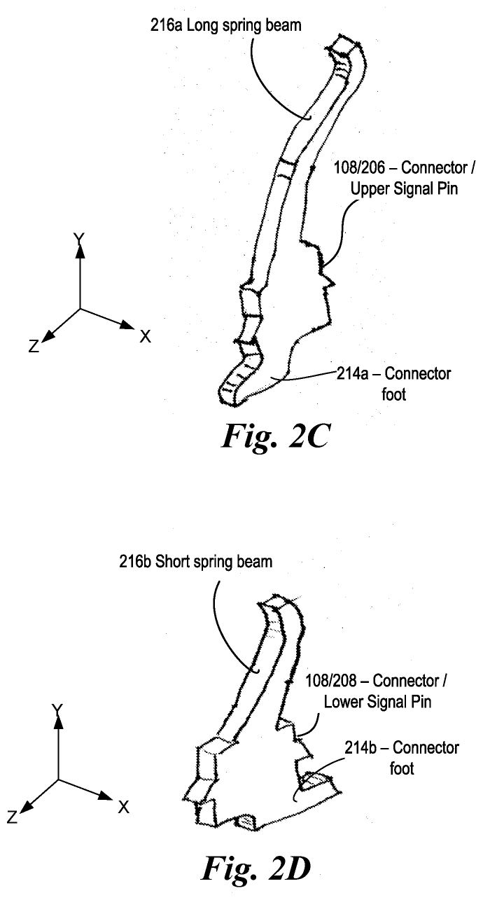

FIGS. 2A-2D are perspective views of various connector pins 108 for reducing crosstalk in accordance with embodiments described herein.

In FIGS. 2A and 2B, a connector ground pin 108/202 can be shaped in the form of a single pin having an upper signal ground pin portion 204a and a lower signal ground pin portion 204b. In one embodiment, the two portions 204a/204b can be shaped as two separate pin halves that are positioned next to one another in a single plane in the connector housing 102 to form the single ground pin 202.

The ground pin 202 includes a long spring beam 116a and a short spring beam 116b, where the long spring beam sits higher in the connector 100 and the short spring beam sits lower. The contour of the long spring beam is curved to make contact with an upper ground pin contact at the upper level of contact point 118a on the contact 106 and the contour of the short spring beam curved to make contact with a lower ground pin contact at the lower level of contact point 118b on the contact 106. The lower ground pin contact point on the contact 106 typically lies directly beneath the upper ground pin contact point on the contact.

In one embodiment, each ground pin 202 includes two connector feet 114a/114b, one on the bottom of the upper signal ground pin portion 204a and another on the bottom of the lower signal ground pin portion 204b. When the ground pin 202 is set into the connector, the connector feet 114 make contact with the MB 112 through corresponding portions of the SMT 110. In one embodiment, the ground pin 202 can include both an outward facing connector foot 114a and an inward facing connector foot 114b, or can include a single connector foot as illustrated in FIG. 2B that spans the width of both the upper signal ground pin portion 204a and the lower signal ground pin portion 204b.

In FIG. 2C, a connector/upper signal pin 108/206 can be formed as a single pin that includes a long spring beam 216a and a single connector foot 214a. The long spring beam 216a of the upper signal pin 206 is shaped with a contour that is similar to or identical to the long spring beam 116a of the ground pin 202, and is likewise curved to make contact with an upper contact at the level of the contact point 118a on the contact 106. The upper contact point 118a on the contact 106 is typically located at the same height as the above-described upper ground pin contact point. In one embodiment, the long spring beam 116a of the ground pin matches the contour of the long spring beam 216a of the upper signal pin 206 to provide the return path of the signal.

In FIG. 2D, a connector/lower signal pin 108/208 can be formed as a single pin that includes a short spring beam 216b and a single connector foot 214b. The short spring beam 216b of the lower signal pin 208 is shaped with a contour that is similar to or identical to the short spring beam 116b of the ground pin 202, and is likewise curved to make contact with a lower signal contact at the level of contact point 118b on the contact 106. The lower signal contact point 118b on the contact 106 is typically at the same height as the above-described lower ground pin contact point. In one embodiment, the short spring beam 116b of the ground pin matches the contour of the short spring beam 216b of the lower signal pin 208 to provide the return path of the signal.

Various embodiments of connector pins 108 can be manufactured by stamping and forming a metal such as, but not limited to, one or more of: copper, bronze, alloy (e.g., a combination of two or more metals), or any electrical or optical signal conductor. The thickness of the ground pins and distance between sides of ground pins can be set so that ground pins do not contact either of the proximate upper signal pins or lower signal pins when positioned in a connector. Blanked pin manufacturing can control connector pin thickness and shape to ensure the interface to the MB 112 (e.g., the interface to the SMT pads 110) and the interface to the device 104 (e.g., the interface to contact 106) fall within specified locations or contact points. In some examples, a thickness of a cross section of a ground pin leg/foot can be approximately 0.1 mm, although other thicknesses can be used. The various connector pins 108 can have a cross section that is circular, oval, rectangular, square, triangular, elliptical, or a combination thereof.

As will be described in further detail below, the above-described shapes of the various connector pins 108 enable a single ground pin 202 to provide the functional equivalent of two ground pins 202 between two signal pins, including an upper signal pin 206 and a lower signal pin 208, each signal pin having its own separate signal return path.

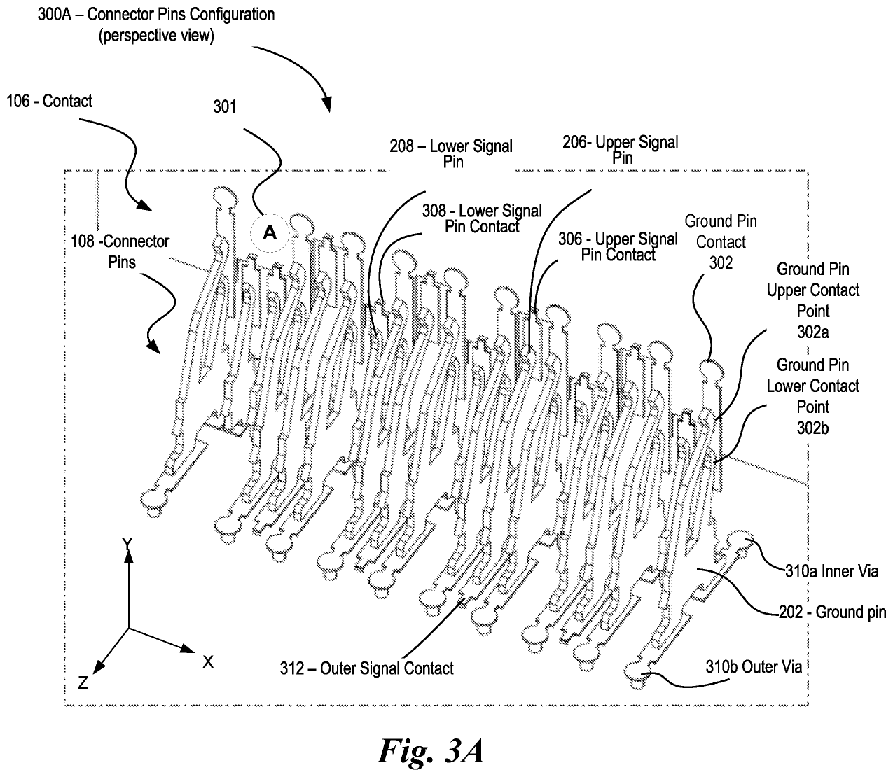

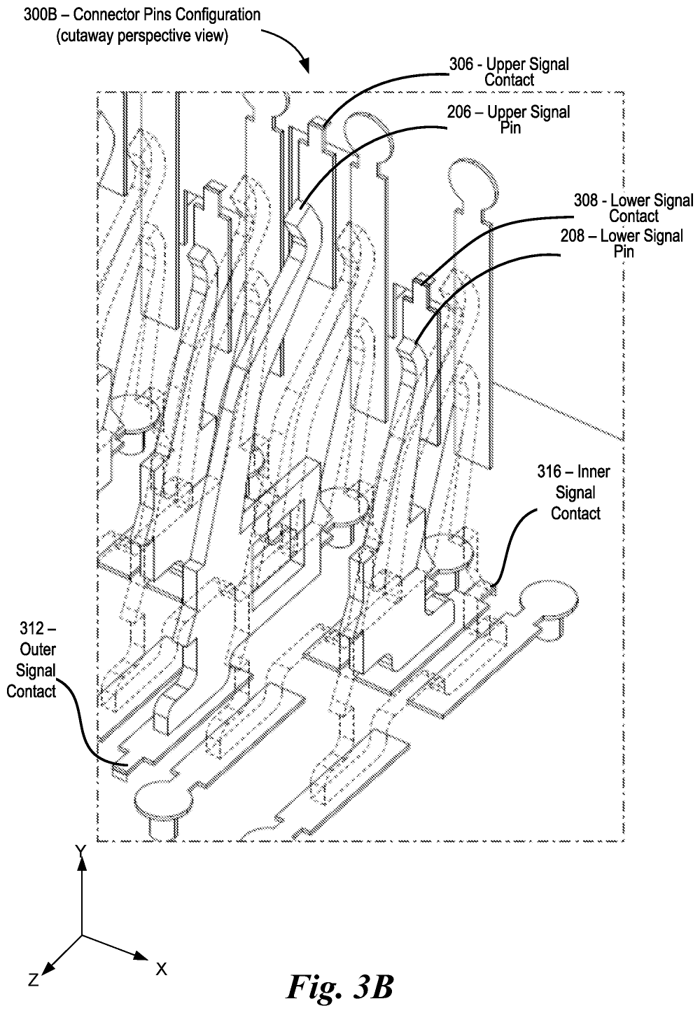

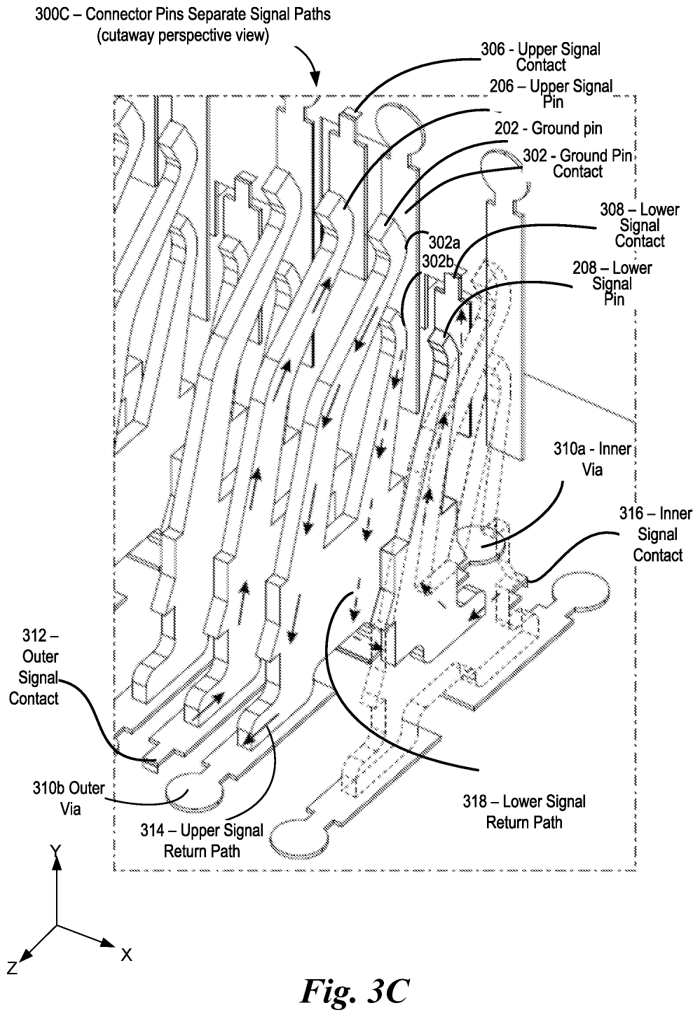

FIGS. 3A-3C are perspective partial views of various connector pins of a connector configured to reduce crosstalk in accordance with embodiments described herein. Specifically, a portion of one side of the connector pins 108 in a connector 100, such as the front side of the connector depicted in FIG. 1, is shown in perspective. The back side of the connector 100 (not shown) would reveal a similar mirror view. FIGS. 3A-3C show examples of a ground pin and signal pin arrangement and design to reduce crosstalk in accordance with embodiments described herein. Other arrangements of the connector pins 108 can be implemented to reduce crosstalk in the manner described.

In one embodiment, connector pins 108 are set in the connector 100 perpendicular to the contact 106 and parallel to each other. As shown in FIG. 3A in the perspective view 300A, in one embodiment each connector foot 114 of ground pin 202 sits above a respective inner via 310a and outer via 310b to make contact with the MB 112 through corresponding portions of the SMT 110. A ground pin contact 302 provides the ground pin upper and lower contact points 302a/302b (118a/118b, FIG. 1) on which the curved portions of the long spring beam 116a and short spring beam 116b of the ground pin 202 make their respective electrical connections with contact 106 of device 104.

As shown in FIG. 3A, in one embodiment a connector foot 214a of an upper signal pin 206 sits above an outer signal contact 312 to make contact with MB 112 through corresponding portions of the SMT 110. As shown in the cutaway perspective view 300B of FIG. 3B depicting additional detail of the connector pins 108, the lower signal pin 208 also makes contact with MB 112 through corresponding portions of the SMT 110 through an inner signal contact 316.

As shown in FIG. 3A, in one embodiment, an upper signal contact 306 provides the upper signal pin 206 contact point on which the curved portion of the long spring beam 216a makes an electrical connection with contact 106 of device 104, and a lower signal contact 308 provides the lower signal pin 208 contact point on which the curved portion of the short spring beam 216b also makes an electrical connection with contact 106 of device 104. The upper signal contact 306 and lower signal contact 308 are positioned at a respective upper and lower height or level so that the spring beams of the signal pins can make an electrical connection with the contact 106 at the same respective height or level as the contact points 118a/118b illustrated in FIG. 1.

As shown in FIG. 3A, in one embodiment the connector pins 108 are placed in a pattern to reduce crosstalk, such that each signal pin 206/208 has at least one neighboring ground pin 202. For example, in the illustrated perspective view in FIG. 3A, there is one location A 301 with two consecutively placed lower signal pins 208 with a neighboring ground pin 202 on each side, as well as singly placed lower signal pins 208 with neighboring ground pins 202 placed on each side along the remaining portion of the connector pins 108. Likewise, the upper signal pins 206 are each flanked by neighboring ground pins 202.

As shown in FIG. 3C, in the cutaway perspective view 300C, in one embodiment, a single ground pin 202 is able to provide two separate return paths for a neighboring upper signal pin 206 and lower signal pin 208. As shown, an upper signal traversing the upper signal pin 206 from the outer signal contact 312 (with the MB 112) to the upper signal contact 306 (with the device 104) has an upper signal return path 314 on the ground pin 202, from the ground pin contact 302 at upper contact point 302a returning to the to the outer via 310b. Likewise, a lower signal traversing the lower signal pin 208 from the inner signal contact 316 (with the MB 112) to the lower signal contact 308 (with the device 104) has a separate lower signal return path 318 on the same ground pin 202, from the ground pin contact 302 at lower contact point 302b returning to the inner via 310a.

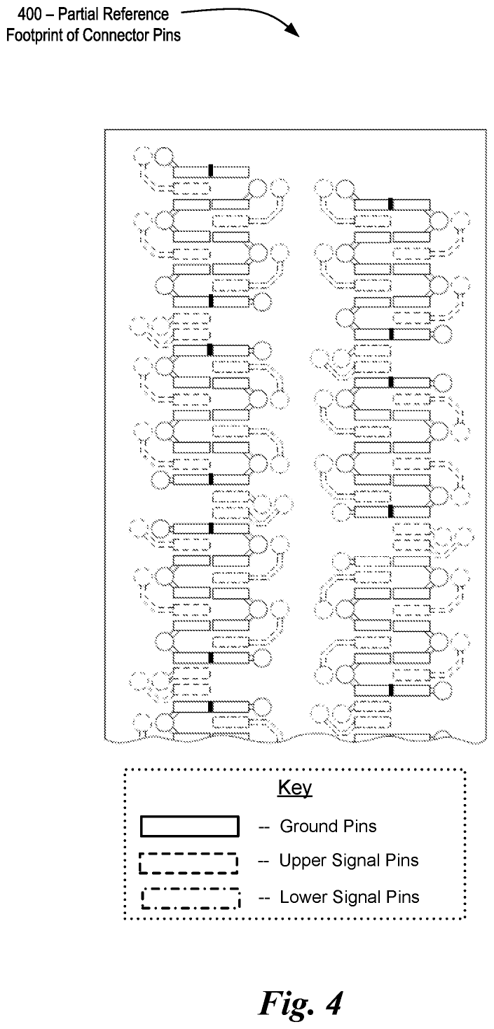

FIG. 4 is a plan view of a partial reference footprint 400 of a connector having various connector pins for reducing crosstalk in accordance with embodiments described herein. In one embodiment, as shown in the reference footprint and reference routing therein, the via place of the connector is stacked to open space to route one memory channel on a single layer.

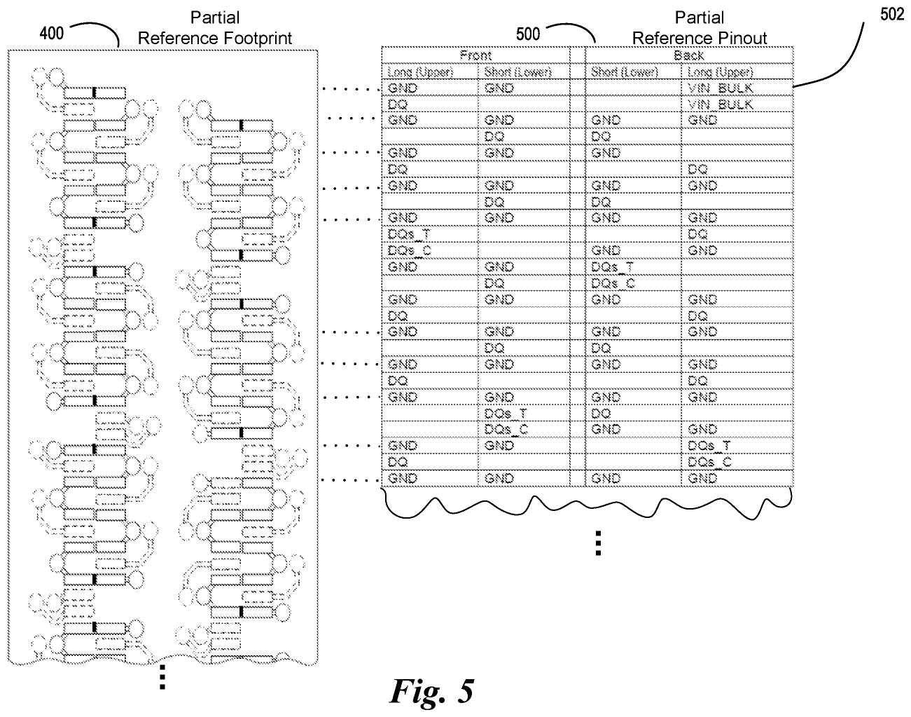

FIG. 5 is a plan view of the partial reference footprint 400 of FIG. 4 and a corresponding reference pinout 500 of a connector 100 having various connector pins 108 for reducing crosstalk in accordance with embodiments described herein. The uppermost upper long pin on the back side of the connector 100 can be used for a power pin 502 to support a hot plug if needed (e.g., VIN_BULK input power supply).

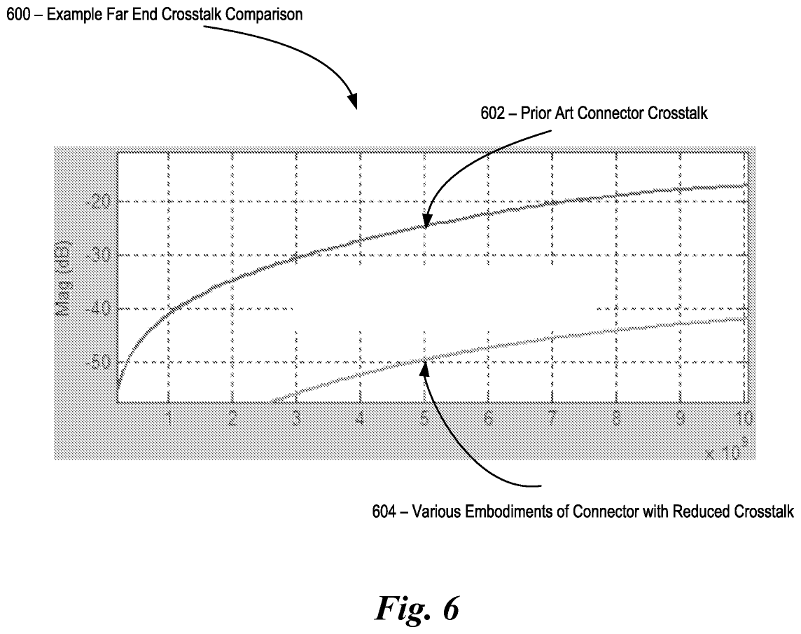

FIG. 6 is a graph illustrating an example comparison of prior art connector (e.g., a DDR5 connector) far end crosstalk (FEXT) and far end crosstalk (FEXT) for a connector having various connector pins for reducing crosstalk in accordance with embodiments described herein. Using various embodiments that enable a single ground pin to provide independent and separate signal return paths for multiple differently shaped signal pins, the FEXT can be reduced by as much as 25 dB (decibels) at 5 GHz (gigahertz).

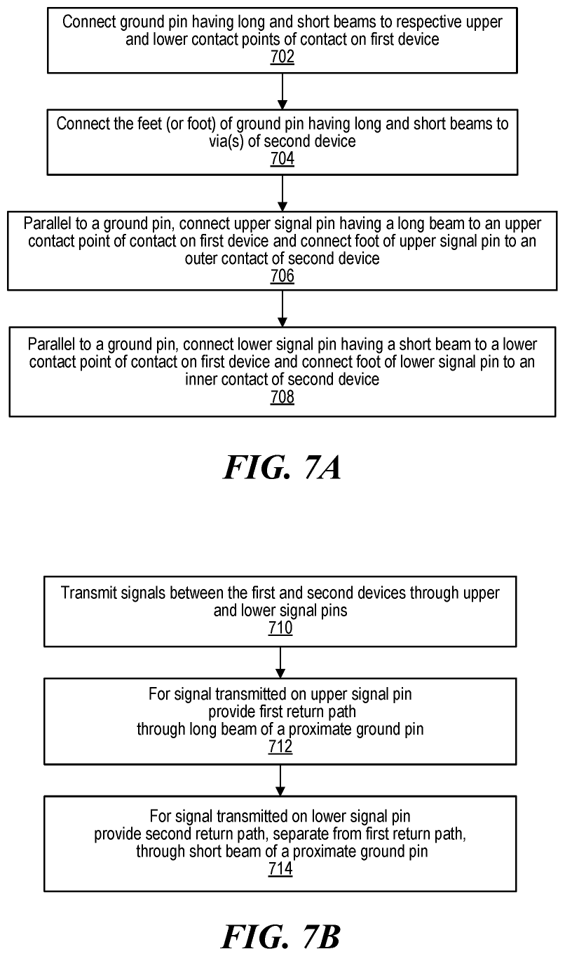

FIGS. 7A-7B are flow diagrams illustrating example processes for implementing a connector having various connector pins for reducing crosstalk in accordance with embodiments described herein.

FIG. 7A depicts an example process that can be used to form a connector between first and second devices in which the connector includes various connector pins for reducing crosstalk in accordance with embodiments described herein. In one embodiment, at 702, a ground pin having long beams and short beams is seated in a connector so that the ground pin can make contact with respective upper and lower contact points of a contact on a first device, such as a memory module (e.g., a DIMM, CAMM or an add-in card (AIC)). At process 704, the ground pin's foot (or, in some embodiments, feet) is seated in the connector so that the ground pin can make contact with a via or other type of contact point to connect to a second device, such as a motherboard (MB). For example, the ground pin foot (or feet) can make contact with the MB using surface mount technology (SMT).

In one embodiment, at 706, parallel to a seated ground pin, an upper signal pin having a long beam is seated in the connector so that the signal pin can make contact with an upper contact point of the contact on the first device. The upper signal pin's foot is seated in the connector so that the upper signal pin can make contact with an outer contact of the second device. Likewise, at 708, parallel to a seated ground pin, a lower signal pin having a short beam is seated in the connector so that the lower signal pin can make contact with a lower contact point of the contact on the first device. The lower signal pin's foot is seated in the connector so that the lower signal pin can make contact with an inner contact of the second device.

In a typical embodiment, the processes at 702, 704, 706 and 708 are repeated to seat multiple ground pins and signal pins in a particular pin pattern such as the pattern illustrated in the partial reference footprint 400 of FIG. 4 and corresponding partial reference pinout 500 of FIG. 5. The contact on the first device is perpendicular to the via or other type of contact point(s) on the second device such that the ground pins and signal pins are seated perpendicular to both the first and second devices and parallel to each other.

FIG. 7B illustrates an example process for transmitting signals between the first device to the second device with the connector having ground pins and signal pins seated as described in FIG. 7A. In one embodiment, at 710, signals are transmitted between the first and second devices through the upper and lower pins. At 712, for a signal transmitted on an upper signal pin, the long beam portion of a proximate ground pin provides a first return path for the upper signal. In contrast, at 714, for a signal transmitted on a lower signal pin, the short beam portion of the proximate ground pin provides a second return path for the lower signal, where the second return path is separate from the first return path, even though the return paths for both the upper and lower signals traverse the same proximate ground pin (with the upper signal pin seated on one side of the ground pin and the lower signal pin seated on the other side). In this manner, the connector can reduce crosstalk in accordance with embodiments described herein.

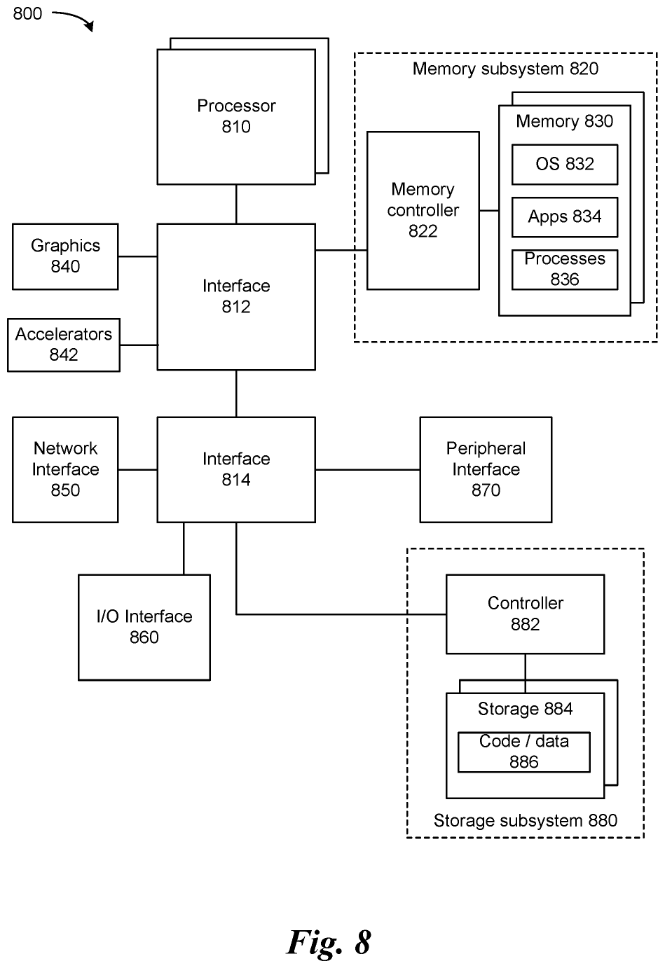

FIG. 8 depicts a system. The system can use embodiments described herein to provide ground pin connections to connect devices and provide a signal to ground ratio of 1:N, where N is greater than 1. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 with the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. Various embodiments can be used in connection with network interface 850, processor 810, and memory subsystem 820.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In some embodiments, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 800. More specifically, power source typically interfaces to one or multiple power supplies in system 800 to provide power to the components of system 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 800 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Additional example implementations are as follows:

Example 1 is a method, system, apparatus or computer-readable medium in which an embodiment of connector pins for reducing crosstalk can be implemented, comprising a first signal pin having a first shape, a second signal pin having a second shape different from the first shape and a ground pin positioned between any two of the first and second signal pins, wherein the ground pin comprises a first portion corresponding to the first shape of the first signal pin and a second portion corresponding to the second shape of the second signal pin, the first portion to provide a first return path for signals on the first signal pin, and the second portion to provide a second return path for signals on the second signal pin, the first return path independent of the second return path.

Example 2 is the method, system, apparatus or computer-readable medium as in Example 1, wherein the first signal pin is a lower signal pin having a short spring beam to connect to a device at a first contact point, the second signal pin is an upper signal pin having a long spring beam to connect to the device at a second contact point, the first portion of the ground pin has a spring beam corresponding to the short spring beam and the second portion of the ground pin has a spring beam corresponding to the long spring beam, the ground pin to connect to the device at contact points corresponding to the respective first and second contact points to provide the first and second return paths.

Example 3 is the method, system, apparatus or computer-readable medium as in any of Examples 1 and 2, wherein the device comprises a memory module, including any of a dual in-line memory module (DIMM), a compression attached memory module (CAMM) and an add-in card (AIC).

Example 4 is the method, system, apparatus or computer-readable medium as in any of Examples 1, 2 and 3, wherein the first signal pin has a connector foot to connect to a motherboard (MB) at a first location, the second signal pin has a connector foot to connect to the MB at a second location and the ground pin has one or more connector feet to connect to the MB at locations corresponding to the respective first and second locations to provide the first and second return paths.

Example 5 is the method, system, apparatus or computer-readable medium as in any of Examples 1, 2, 3 and 4, wherein the first portion of the ground pin has a connector foot coupled to a first surface mounted (SMT) connector of a motherboard (MB), the second portion of the ground pin has a second connector foot coupled to a second SMT connector of the MB, the first SMT corresponding to the first return path and the second SMT corresponding to the second return path, the first portion of the ground pin includes an individual pin separate from the second portion of the ground pin and the second portion of the ground pin includes an individual pin separate from the first portion of the ground pin, the first portion oriented in a same plane as the second portion to form the ground pin.

Example 6 is the method, system, apparatus or computer-readable medium as in any of Examples 1, 2, 3, 4 and 5, wherein the first signal pin, the second signal pin and ground pin are oriented parallel to each other.

Example 7 is the method, system, apparatus or computer-readable medium as in any of Examples 1, 2, 3, 4, 5 and 6, wherein any of the first signal pin, the second signal pin and the ground pin comprise one or more of: copper, bronze, or an alloy.

Example 8 is the method, system, apparatus or computer-readable medium as in any of Examples 1, 2, 3, 4, 5, 6 and 7, wherein the first signal pin, the second signal pin and the ground pin are positioned consistent with a specification of the Joint Electronic Device Engineering Council Double Data Rate (DDR).

Example 9 is a method, system, apparatus or computer-readable medium in which an embodiment of connector pins for reducing crosstalk can be implemented, comprising a first device, a second device and a connector connecting the first device to the second device, the connector including connector pins arranged to reduce crosstalk between signals to the first and second device, the connector pins including a lower signal pin, an upper signal pin and a ground pin positioned between any two of the upper signal pin and the lower signal pin, wherein the ground pin comprises a lower portion corresponding to the lower signal pin and an upper portion corresponding to the upper signal pin, the lower portion to provide a first return path for signals on the lower signal pin and the upper portion to provide a second return path for signals on the upper signal pin, the first return path independent of the second return path.

Example 10 is the method, system, apparatus or computer-readable medium as in Example 9, wherein a short spring beam of the lower signal pin is to connect to the first device at a first contact point, a long spring beam of the upper signal pin is to connect to the first device at a second contact point above the first contact point, the lower portion of the ground pin includes a first spring beam corresponding to the short spring beam of the lower signal pin and the upper portion of the ground pin includes a second spring beam corresponding to the long spring beam of the upper signal pin, the first spring beam and second spring beam of the ground pin to connect to the first device at contact points corresponding to the respective first contact point and second contact point to provide the first and second return paths.

Example 11 is the method, system, apparatus or computer-readable medium as in any of Examples 9 and 10, wherein the first device includes a memory module, including any of a dual in-line memory module (DIMM) and a compression attached memory module (CAMM), and an add-in card (AIC).

Example 12 is the method, system, apparatus or computer-readable medium as in any of Examples 9, 10 and 11, wherein the lower signal pin has a connector foot to connect to the second device at a first location, the upper signal pin has a connector foot to connect to the second device at a second location and the ground pin has one or more connector feet to connect to the second device at locations corresponding to the respective first location and second location to provide the first and second return paths.

Example 13 is the method, system, apparatus or computer-readable medium as in any of Examples 9, 10, 11 and 12, wherein the second device is a printed circuit board (PCB), including a motherboard (MB), the lower portion of the ground pin has a connector foot coupled to a first surface mounted (SMT) connector of the MB, the upper portion of the ground pin has a second connector foot coupled to a second SMT connector of the MB, the first SMT corresponding to the first return path and the second SMT corresponding to the second return path, the upper portion of the ground pin includes an individual pin separate from the lower portion of the ground pin and the lower portion of the ground pin includes an individual pin separate from the upper portion of the ground pin, the upper portion of the ground pin and the lower portion of the ground pin positioned in the connector in a same plane to form the ground pin.

Example 14 is the method, system, apparatus or computer-readable medium as in any of Examples 9, 10, 11, 12 and 13, wherein the connector pins are positioned in the connector parallel to each other.

Example 15 is the method, system, apparatus or computer-readable medium as in any of Examples 9, 10, 11, 12, 13 and 14, wherein any of the lower signal pin, the upper signal pin and the ground pin comprise one or more of: copper, bronze, or an alloy.

Example 16 is the method, system, apparatus or computer-readable medium as in any of Examples 9, 10, 11, 12, 13, 14 and 15, wherein the lower signal pin, the upper signal pin and the ground pin are positioned in the connector consistent with a specification of the Joint Electronic Device Engineering Council Double Data Rate (DDR).

Example 17 is a method, system, apparatus or computer-readable medium in which an embodiment of connector pins for reducing crosstalk can be implemented, comprising connector pins to carry signals between a device and a printed circuit board (PCB), including a lower signal pin having a short spring beam to connect to the device at a lower contact point and an inward facing foot to connect to the PCB at an inner signal contact, an upper signal pin having a long spring beam to connect to the device at a higher contact point than the lower contact point and an outward facing foot to connect to the PCB at an outer signal contact, a ground pin having a short spring beam and a long spring beam, the ground pin having an inward facing foot to connect to the PCB at an inner via and an outward facing foot to connect to the PCB at an outer via, and wherein the ground pin is to be positioned between any two of the upper signal pin and the lower signal pin, provide a first return path to the PCB at the inner via for signals on the lower signal pin along the short spring beam of the ground pin, and provide a second return path to the PCB at the outer via for signals on the upper signal pin along the long spring beam of the ground pin, the first return path independent of the second return path.

Example 18 is the method, system, apparatus or computer-readable medium as in Example 17, wherein the device includes any of a memory module, including any of a dual in-line memory module (DIMM) and a compression attached memory module (CAMM), and an add-in card (AIC).

Example 19 is the method, system, apparatus or computer-readable medium as in any of Examples 17 and 18, wherein the PCB comprises a motherboard (MB) having surface mount technology (SMT), the inward facing foot of the lower signal pin to connect to the MB at the inner signal contact, the outward facing foot of the upper signal pin to connect to the MB at the outer signal contact, the inward facing foot of the ground pin to connect to the MB at the inner via, the outward facing foot of the ground pin to connect to the MB at the outer via, the ground pin including a single foot combining the inward facing foot and the outward facing foot and the ground pin including a first pin having the short spring beam and a second pin having the long spring beam, the first pin positioned in a same plane as the second pin.

Example 20 is the method, system, apparatus or computer-readable medium as in any of Examples 17, 18 and 19, wherein the connector pins are positioned in the connector device parallel to each other and consistent with a specification of the Joint Electronic Device Engineering Council Double Data Rate (DDR) and comprise one or more of: copper, bronze, or an alloy.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is noted that the views, block diagrams and the like in the drawings are illustrative and not drawn to scale. For example, the relative dimensions and placements for some of the components in the views and block diagrams herein are exaggerated for clarity and point of illustration. For example, one having skill in the art will recognize the components in an actual implementation will generally have dimensions and thicknesses that are different than that shown in the Figures herein (e.g., substantially smaller and/or thinner), or be placed in a manner that is different from what is represented in a block diagram or other illustration.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

What is claimed is:

1. An apparatus comprising:
a first signal pin having a first shape;
a second signal pin having a second shape different from the first shape; and
a ground pin positioned between any two of the first and second signal pins, wherein:
the ground pin comprises a first portion corresponding to the first shape of the first signal pin and a second portion corresponding to the second shape of the second signal pin,
the first portion to provide a first return path for signals on the first signal pin, and
the second portion to provide a second return path for signals on the second signal pin, the first return path independent of the second return path.

2. The apparatus of claim 1, wherein:
the first signal pin is a lower signal pin having a short spring beam to connect to a device at a first contact point;
the second signal pin is an upper signal pin having a long spring beam to connect to the device at a second contact point;
the first portion of the ground pin has a spring beam corresponding to the short spring beam; and
the second portion of the ground pin has a spring beam corresponding to the long spring beam, the ground pin to connect to the device at contact points corresponding to the respective first and second contact points to provide the first and second return paths.

3. The apparatus of claim 2, wherein the device comprises a memory module, including any of a dual in-line memory module (DIMM), a compression attached memory module (CAMM) and an add-in card (AIC).

4. The apparatus of claim 1, wherein:
the first signal pin has a connector foot to connect to a motherboard (MB) at a first location;
the second signal pin has a connector foot to connect to the MB at a second location; and
the ground pin has one or more connector feet to connect to the MB at locations corresponding to the respective first and second locations to provide the first and second return paths.

5. The apparatus of claim 1, wherein:
the first portion of the ground pin has a connector foot coupled to a first surface mounted (SMT) connector of a motherboard (MB);
the second portion of the ground pin has a second connector foot coupled to a second SMT connector of the MB, the first SMT corresponding to the first return path and the second SMT corresponding to the second return path;
the first portion of the ground pin includes an individual pin separate from the second portion of the ground pin; and
the second portion of the ground pin includes an individual pin separate from the first portion of the ground pin, the first portion oriented in a same plane as the second portion to form the ground pin.

6. The apparatus of claim 1, wherein the first signal pin, the second signal pin and ground pin are oriented parallel to each other.

7. The apparatus of claim 1, wherein any of the first signal pin, the second signal pin and the ground pin comprise one or more of: copper, bronze, or an alloy.

8. The apparatus of claim 1, wherein the first signal pin, the second signal pin and the ground pin are positioned consistent with a specification of the Joint Electronic Device Engineering Council Double Data Rate (DDR).

9. A system comprising:
a first device;
a second device; and
a connector connecting the first device to the second device, the connector including connector pins arranged to reduce crosstalk between signals to the first and second device, the connector pins including:
a lower signal pin;
an upper signal pin; and
a ground pin positioned between any two of the upper signal pin and the lower signal pin, wherein:
the ground pin comprises a lower portion corresponding to the lower signal pin and an upper portion corresponding to the upper signal pin,
the lower portion to provide a first return path for signals on the lower signal pin, and
the upper portion to provide a second return path for signals on the upper signal pin, the first return path independent of the second return path.

10. The system of claim 9, wherein:
a short spring beam of the lower signal pin, the short spring beam to connect to the first device at a first contact point;
a long spring beam of the upper signal pin, the long spring beam to connect to the first device at a second contact point above the first contact point;
the lower portion of the ground pin includes a first spring beam corresponding to the short spring beam of the lower signal pin; and
the upper portion of the ground pin includes a second spring beam corresponding to the long spring beam of the upper signal pin, the first spring beam and second spring beam of the ground pin to connect to the first device at contact points corresponding to the respective first contact point and second contact point to provide the first and second return paths.

11. The system of claim 9, wherein the first device includes a memory module, including any of a dual in-line memory module (DIMM) and a compression attached memory module (CAMM), and an add-in card (AIC).

12. The system of claim 9, wherein:
the lower signal pin has a connector foot to connect to the second device at a first location;
the upper signal pin has a connector foot to connect to the second device at a second location; and
the ground pin has one or more connector feet to connect to the second device at locations corresponding to the respective first location and second location to provide the first and second return paths.

13. The system of claim 9, wherein:
the second device is a printed circuit board (PCB), including a motherboard (MB);
the lower portion of the ground pin has a connector foot coupled to a first surface mounted (SMT) connector of the MB;
the upper portion of the ground pin has a second connector foot coupled to a second SMT connector of the MB, the first SMT corresponding to the first return path and the second SMT corresponding to the second return path;
the upper portion of the ground pin includes an individual pin separate from the lower portion of the ground pin; and
the lower portion of the ground pin includes an individual pin separate from the upper portion of the ground pin, the upper portion of the ground pin and the lower portion of the ground pin positioned in the connector in a same plane to form the ground pin.

14. The system of claim 9, wherein the connector pins are positioned in the connector parallel to each other.

15. The system of claim 9, wherein any of the lower signal pin, the upper signal pin and the ground pin comprise one or more of: copper, bronze, or an alloy.

16. The system of claim 9, wherein the lower signal pin, the upper signal pin and the ground pin are positioned in the connector consistent with a specification of the Joint Electronic Device Engineering Council Double Data Rate (DDR).

17. A connector device comprising:
connector pins to carry signals between a device and a printed circuit board (PCB), including:
a lower signal pin having a short spring beam to connect to the device at a lower contact point and an inward facing foot to connect to the PCB at an inner signal contact;
an upper signal pin having a long spring beam to connect to the device at a higher contact point than the lower contact point and an outward facing foot to connect to the PCB at an outer signal contact;
a ground pin having a short spring beam and a long spring beam;
the ground pin having an inward facing foot to connect to the PCB at an inner via and an outward facing foot to connect to the PCB at an outer via; and
wherein the ground pin is to:
be positioned between any two of the upper signal pin and the lower signal pin,
provide a first return path to the PCB at the inner via for signals on the lower signal pin along the short spring beam of the ground pin, and
provide a second return path to the PCB at the outer via for signals on the upper signal pin along the long spring beam of the ground pin, the first return path independent of the second return path.

18. The connector device of claim 17, wherein the device includes any of a memory module, including any of a dual in-line memory module (DIMM) and a compression attached memory module (CAMM), and an add-in card (AIC).

19. The connector device of claim 17, wherein:
the PCB comprises a motherboard (MB) having surface mount technology (SMT);
the inward facing foot of the lower signal pin to connect to the MB at the inner signal contact;
the outward facing foot of the upper signal pin to connect to the MB at the outer signal contact;
the inward facing foot of the ground pin to connect to the MB at the inner via;
the outward facing foot of the ground pin to connect to the MB at the outer via;
the ground pin including a single foot combining the inward facing foot and the outward facing foot; and
the ground pin including a first pin having the short spring beam and a second pin having the long spring beam, the first pin positioned in a same plane as the second pin.

20. The connector device of claim 17, wherein the connector pins:
are positioned in the connector device parallel to each other and consistent with a specification of the Joint Electronic Device Engineering Council Double Data Rate (DDR); and
comprise one or more of: copper, bronze, or an alloy.
